(19) United States
(12) Patent Application Publication
(10) Pub. No.: US 2019/0301647 A1
(43) Pub. Date: Oct. 3, 2019

(54) HYDRAULIC COMPONENT SYSTEM HAVING A HYDRAULIC COMPONENT PRODUCED AT LEAST IN PART BY A GENERATIVE METHOD

(71) Applicant: Airbus Operations GmbH, Hamburg (DE)

(72) Inventors: Julian WEBER, Hamburg (DE); Sten SCHEFFER, Hamburg (DE)

(21) Appl. No.: 16/353,437

(22) Filed: Mar. 14, 2019

(30) Foreign Application Priority Data
Mar. 27, 2018 (DE) 102018107299.6

(51) Int. Cl. F16L 19/04

(52) U.S. Cl. CPC F16L 19/043

(57) ABSTRACT

A hydraulic component system has a hydraulic line, a hydraulic component produced by a generative method, an annular sealing means, and a hollow fastening element. The sealing means has opposing end regions. The fastening element has an engagement region with an internally arranged circumferential surface having second engagement means and has an opposite clamping region having a second axial contact surface facing the engagement region, and is designed to surround the hydraulic line and the sealing means, and to bring about a surface contact between the first and the second axial contact surface. The receiving section, the sealing means, and the fastening element correspond to one another such that the first end region of the sealing means is pressed into the conically tapering region of the opening of the receiving section and the hydraulic line by engagement of the first and second engagement means.

CROSS-REFERENCE TO PRIORITY APPLICATION

This application claims the benefit of, and priority to, German patent application number DE 102018107299.6, filed Mar. 27, 2018. The content of the referenced application is incorporated by reference herein.

### TECHNICAL FIELD

Embodiments of the subject matter described herein relate generally to a hydraulic component system. Embodiments of the subject matter also relate to a vehicle and, in particular, to an aircraft in which a hydraulic component system of this kind is arranged.

### BACKGROUND

The use of hydraulic devices for a very wide variety of tasks is known in many stationary and mobile machines and vehicles. These generally require a network of hydraulic lines, couplings and suitable valves. For more complex devices, valve or control blocks are often used, by means of which valve functions are concentrated in a compact unit. One known practice for reducing the weight of a control block of this kind is to implement said block in a lightweight metal design.

A method for producing a control block in a lightweight metal design is known from patent publication DE 10 2006 062 373 A1, for instance, in which a system of circuit elements is embodied with walls appropriate to the loads, which are connected directly or by means of additional elements to form a coherent structure and which are all produced by a generative manufacturing method.

To attach hydraulic lines to a control block produced with the aid of a generative manufacturing method, consideration is generally given to conventional, standardized and widely available coupling devices. For this purpose, the control block can have corresponding openings, into which a screw spigot is screwed, to which further components can then be connected. An opening to be provided with a screw spigot has a hole with an internal thread and sealing surfaces. Owing to the geometry of the screw spigot, a maximum diameter for an annular sealing surface surrounding the opening is larger by a factor of approximately 3 than an inside diameter of the opening. For this type of joint, a large accumulation of material relative to the available flow channel is therefore necessary. The volume of solid material, i.e. the metallic material of the screw spigot and of the hydraulic component, is about 8 times the volume of the oil volume available therein in the region of the joint.

In addition, by virtue of the design, a through hole in the screw spigot has a smaller diameter than the openings. Consequently, a relatively large accumulation of material is required for the inside diameter relative to the flow channel in this type of joint. Particularly in the case of control blocks produced by a generative method, this leads to quite a large amount of effort, a relatively large amount of material consumed, relatively high costs and, not least, to a higher weight, which should be minimized especially when using such a control block in an aircraft.

### BRIEF SUMMARY

It is accordingly one object of the disclosure to propose a hydraulic component or a hydraulic component system having a hydraulic component of this kind in which economical production by means of a generative production method is favored and, at the same time, the weight and accumulation of material can be reduced.

The object is achieved by a hydraulic component system having the features of independent Claim 1. Advantageous embodiments and developments can be found in the dependent claims and the following description.

The proposal is for a hydraulic component system which has at least one hydraulic line, a hydraulic component, which is produced at least in part with the aid of a generative production method and has a line end with an integral annular receiving section having an outer circumferential surface that has first engagement means and an opening for the insertion of the hydraulic line, said opening tapering conically, at least in some region or regions, an annular sealing means, which can be positioned on the hydraulic line, and a hollow fastening element, which can be positioned on the hydraulic line and can be connected to the receiving section. The sealing means has a first end region and an opposite second end region having a first axial contact surface. The fastening element has an engagement region with an internal circumferential surface having second engagement means and has an opposite clamping region having a second axial contact surface facing the engagement region and is designed to surround the hydraulic line and the sealing means situated thereon and to bring about a surface contact between the first and the second axial contact surface. The receiving section, the sealing means and the fastening element are designed to correspond to one another in such a way that the first end region of the sealing means is pressed into the conically tapering region of the opening of the receiving section and the hydraulic line by engagement of the first and second engagement means in one another and, as a result, sealing of the receiving section, the sealing means and the hydraulic line with respect to one another is accomplished.

In particular, the hydraulic line is a pipe conduit which has sufficient dimensional stability. On the one hand, the hydraulic line should be designed to cope with the hydraulic pressure which occurs and, on the other hand, should be suitable to enter into a seal by means of the components explained below. Producing the hydraulic line from a metallic material is recommended.

The hydraulic component can be the control block mentioned above. However, it is also conceivable to design any other hydraulic component in accordance with the disclosure without departing from the central concept of the disclosure. It could, for instance, be desirable to equip a hydraulic pump with a housing part which has been produced with the aid of a generative manufacturing method. The housing part could then have a line end which has the annular receiving section.

The generative manufacturing method mentioned, which is also referred to as additive manufacture, can be based on various processes. For example, the coupling housing to be produced can be manufactured by a selective laser melting method (SLM), a selective laser sintering method (SLS), an electron beam melting method or a binder jetting method. As an alternative, powder, in particular metal powder, application methods and/or liquid composite molding methods can be used, while other generative methods would also be possible. Generative manufacture generally comprises the stratified build-up of a part based on a data model by selective solidification or application of an amorphous material, e.g. a powder or a liquid, and/or a material with a neutral shape, e.g. a material in strip and/or wire form, by means of chemical and/or physical processes. This type of manufacture allows not only a particularly low weight through optimum adaptation to load states of the part which are to be expected and selective omission of material at certain points but also allows a freedom of design, not achievable with other methods, for cavities, flow channels and the like within the hydraulic component.

Depending on the type of method selected, it may be helpful to perform finish machining after the production of the relevant part of the hydraulic component, and this may relate particularly to the machining of the surface, especially the internal surface. In addition to machining with an etching solution, it is also possible to consider allowing liquids containing particles to flow through the part. The aim is to reduce or completely remove any steps that have remained from the generative process on internal surfaces exposed to flow.

The hydraulic component is preferably produced from a metallic material. Hydraulic systems are characterized by high system pressures, which often exceed 100 bar, 200 bar or above, to achieve a particularly high power density. The use of a metallic material makes it possible to withstand such a system pressure. The use of titanium, a titanium alloy, aluminum, an aluminum alloy and/or a stainless steel alloy can be advantageous for this purpose, but other metals or metal alloys are not excluded.

The above mentioned line end can be regarded as one end of a line section which forms an integral part of the hydraulic component. In particular, the line end is an end of a tubular section which projects from the hydraulic component and allows connection to the hydraulic line. The annular receiving section preferably has a continuous circumference to enable an adequate sealing effect to be produced.

The first engagement means are, in particular, surface features which are arranged on the external circumferential surface and allow engagement with the second engagement means. In particular, the first engagement means can be embodied as grooves, which are arranged around the circumferential surface at a predetermined spacing from each other. In this case, the grooves can each be embodied in the manner of a thread. In particular, the grooves can have a thread pitch.

Meanwhile, the hollow fastening element has second engagement means, which can be brought into engagement with the first engagement means. For this purpose, the second engagement means are designed to correspond to the first engagement means and are positioned on the internally arranged circumferential surface. This surface surrounds the outer circumferential surface of the line end and consequently likewise surrounds the sealing means and a section of the hydraulic line which is positioned in the opening and projects through the sealing means. According to the above example, the second engagement means could likewise be grooves with a matching geometry.

The line end has an opening into which the hydraulic line can be inserted. The opening tapers conically in some region or regions, with the result that the cross section of the opening tapers from a first cross section into the line section of the hydraulic component to a second cross section, at least over a certain region. This enables the line end to interact with the sealing means, in particular in the manner of a cutting ring seal or, more generally, by achieving clamping or squeezing forces for sealing.

The sealing means is preferably produced from a metallic material, which is suitable for deforming the material of the hydraulic line, at least to a certain degree. The pressing of the sealing means on the hydraulic line inserted into the opening into the conically tapering opening causes material to accumulate on the hydraulic line directly in front of the end edge of the sealing means, leading to the formation of a collar. This gives rise to a high-pressure-resistant seal between the hydraulic line and the opening.

The fastening element is designed to press the sealing means into the conically tapering opening of the line end via the hydraulic line. It therefore does not necessarily have to have a continuous circumference but could also have claw-like elements which are distributed in a spaced manner relative to one another in a circumferential direction. Overall, the engagement means should be designed in such a way that a sufficient pressing force can be exerted by the fastening element on the sealing means towards the conical opening and that the joint between the fastening element and the receiving section is permanent. Provision can be made to provide a type of retaining element in addition to the securing of the joint.

The embodiment according to the disclosure has a number of advantages. For example, sufficiently less accumulation of material is necessary on the hydraulic component to provide a high-pressure-resistant joint between a hydraulic line and the hydraulic component. The integral receiving section makes it unnecessary to screw in a separate screw spigot, and therefore the seat of the latter with a correspondingly large encircling sealing surface is not necessary either. Moreover, it is thereby possible to prevent a change in the size of a flow cross section.

The inside diameter of the hydraulic line can be continued without any further local constriction by the receiving section into the line end of the hydraulic component. As a result, the flow conditions for the hydraulic fluid are virtually ideal and the flow resistance is almost unaffected by the transition between the hydraulic line and the line end. This entails an additional increase in the efficiency of the hydraulic component concerned.

Moreover, the ratio of the volume of material of the line end in the region of the receiving section to the volume available therein for the hydraulic fluid is less than 2.5, thereby allowing significantly more economical manufacture in comparison with the prior art.

Owing to the integration of a sealing cone, provided by the conically tapering opening, in the additively built up structure, there is only a single sealing point and it is therefore possible by this means to reduce the risk of a possible leak.

As a particular preference, the first end region of the sealing means is sleeve-shaped. The sleeve-shaped configuration allows a flat construction and allows the first end region to be inserted a long way into the conical opening. The formation of a desired shallow cone angle is thereby readily implemented.

Furthermore, the sealing means is preferably a cutting ring. It is possible, in particular, for such a ring to have a 24° slope on a surface of the first end region in order to achieve the cutting or clamping effect to build up the material of the hydraulic line.

In a preferred embodiment, a first flow cross section formed within the receiving section corresponds to a second flow cross section formed within the hydraulic line. A hydraulic fluid can flow into the hydraulic component from the hydraulic line without any change in the flow cross section. As a result, the flow is unaffected and can flow into the hydraulic component without producing an additional resistance. As a result, there is no reduction in efficiency.

Furthermore, the receiving section can have a transitional region, which faces away from the opening and in which an outside diameter of the line end falls continuously along the line end from a maximum outside diameter to a constant line outside diameter in a direction away from the opening, wherein an annular first stop surface, with which a correspondingly shaped annular second stop surface of the fastening element can be brought into surface contact, is formed on a side of the transitional region facing the opening. By means of a transitional region, it is possible to achieve a configuration of the receiving section which is appropriate for the loads. The accumulation of material which is present there leads to adequate strength of the receiving section to absorb the force imposed by the fastening element, which acts both in the radial and in the axial direction. The continuous progress of the outside diameter can, in particular, be steady, preferably monotonic and, particularly preferably, strictly monotonic. As a consequence, notch forces are largely avoided in respect of the transitional region since particularly smooth shaping is achieved. The first stop surface furthermore allows feedback to the user as to when the fastening element is fully fitted, i.e. when the seal between the hydraulic line and the receiving section is complete.

The annular first stop surface can be of conical design, wherein an outside diameter increases from the outer circumferential surface towards the transitional region. The conical shape enlarges the contact surface made available without necessarily entailing the need to enlarge the outside diameter. Moreover, a centering effect is achieved, by means of which a force that acts as precisely as possible axially is generated between the first stop surface and the fastening element.

The opening can have a conically tapering insertion region and a hollow-cylindrical region adjoining the latter, which has an annular boundary surface, which corresponds to an annular end face of the hydraulic line. By means of its funnel-shaped configuration, the insertion region facilitates the insertion of the hydraulic line. The insertion depth of the hydraulic line can be limited by the annular boundary surface. After the insertion of the hydraulic line into the opening, the hydraulic line enters the hollow-cylindrical region and is thus centered in the opening. The inside diameter of the hollow-cylindrical region should be matched to the outside diameter of the hydraulic line in such a way that the hydraulic line can be inserted manually into the hollow-cylindrical region. The inside diameter, for its part, is matched to the inside diameter of the hydraulic line, thus enabling the hydraulic fluid to flow without a transition between the hydraulic line and the line end.

As a particular preference, the diameter of the outer circumferential surface of the receiving section is chosen in such a way that the volume formed by the outer circumferential surface is at most 2.5 times that of the cavity enclosed by the outer circumferential surface. Accordingly, the overall design of the receiving section is very flat and approximately sleeve-shaped. By virtue of the integral construction, the necessary installation space in the radial direction can be significantly reduced since the seal does not require any annular sealing surface situated radially on the outside. Particularly when using a thread as the first and second engagement means, the outside diameter can be significantly limited since the necessary force can be introduced via a relatively large surface area on the outer circumferential surface of the receiving section and on the inner circumferential surface of the fastening means. This is then reflected in the advantageous volume ratio mentioned.

The first engagement means preferably extends over the entire outer circumferential surface, which extends as far as an end edge of the receiving section. Here, the available surface of the receiving section is fully utilized, thus ensuring that a very high clamping force can be exerted on the sealing means, even in the case of metallic material which is not of high strength. The achievable fatigue resistance is furthermore likewise very advantageous since the material stress is relatively low owing to the large area.

In a way which corresponds thereto, the second engagement means can have an axial extent which corresponds at least to 0.9 times the axial extent of the first engagement means. Accordingly, force can be introduced over at least 90% of the area of the first engagement means, leading to lower material stress.

The sealing means is preferably provided on the first end region with a tapering outside diameter, wherein the taper ends in an end edge, and wherein the taper is of corresponding design to the conically tapering opening of the receiving section. Consequently, the inside diameter of the sealing means is constant in the first end region. The taper leads to the formation of a kind of cutting or clamping edge which, in combination with the conically tapering opening, leads to a build-up of material on the hydraulic line. Owing to the mutually matching shape, a particularly effective radial clamping force of the end edge of the sealing means can be achieved through the action of an axial pressure force on the first axial contact surface arranged opposite the end edge.

As a particular preference, the first axial contact surface is a conically shaped annular surface. Consequently, the second axial contact surface, which is situated within the fastening element, is also a conical annular surface or a conical annular section of an inner surface of the fastening element. The conicity can be designed in such a way that the first or second axial contact surface expands towards the end edge. On one hand, the conical configuration can increase the size of the surface included in a surface contact and, on the other hand, it can perform centering of the sealing means on the fastening element. Tilting of the sealing means and impairment of the hydraulic line can thereby be prevented.

The disclosure furthermore relates to a vehicle having a hydraulic component system described above. The vehicle could be an aircraft. The use of the hydraulic component system saves weight and installation space, particularly at the joints between a hydraulic line and a hydraulic component.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Further features, advantages and possible uses of the subject matter will be found in the following description of the embodiment examples and the figures. Here, all the features described and/or depicted, in themselves and in any desired combination, form the subject matter of the disclosure, even when considered independently of their combination in the individual claims or the dependency references thereof. In the figures, the same reference signs furthermore stand for identical or similar objects.

FIG. 1 shows a section through a detail of a hydraulic component system having a hydraulic component, a cutting ring, a fastening element and a hydraulic line.

FIG. 2 shows a three-dimensional depiction of a hydraulic component.

FIG. 3 shows an aircraft in which a hydraulic component system according to the disclosure is installed.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

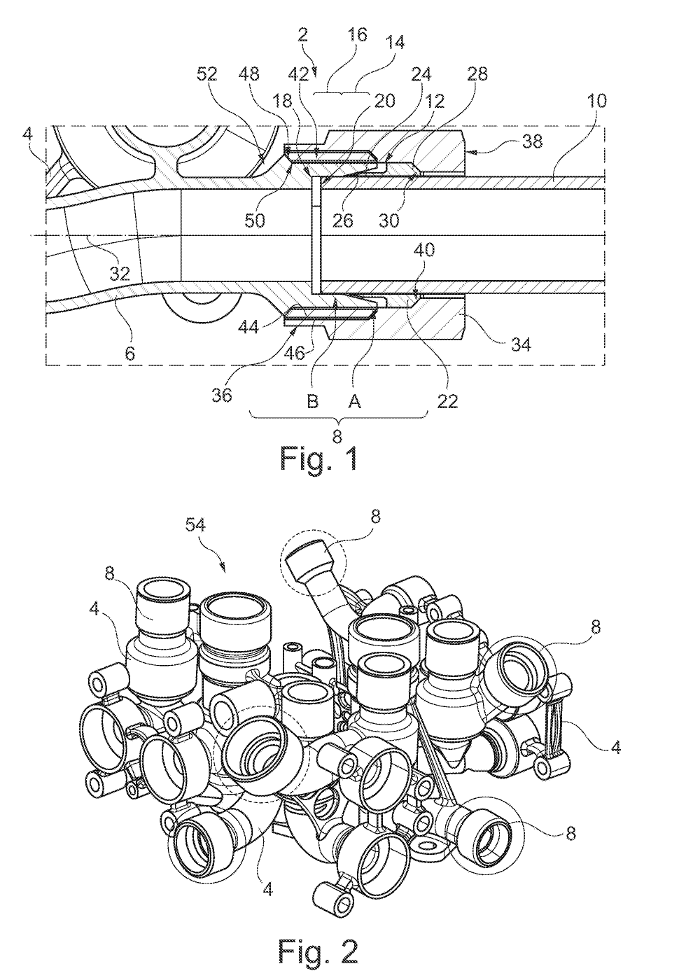

FIG. 1 shows a detail of a hydraulic component system 2 in section. By way of example, it shows a hydraulic component 4 which is produced at least in part by a generative stratified construction method. Particularly the region which is visible in FIG. 1 is produced by a method of this kind, and therefore all the components depicted form a single integral part. In the foreground, the figure shows a line end 6, which is embodied as a pipe section and has a receiving section 8.

The receiving section 8 is designed to receive a hydraulic line 10 and to enter into a high-pressure-resistant joint therewith. For this purpose, the receiving section 8 has an opening 12, which is of conical design in an end region 14, with the result that the cross section of the opening 12 tapers into the line end 6 from a first cross section A to a second cross section B. Directly adjoining this there is a cylindrical section 16, the inside diameter of which is matched to an outside diameter of the hydraulic line 10. An end of the cylindrical region 16 which faces away from the conical region 14 has an annular boundary surface 18, which is configured to correspond to an annular end face 20 of the hydraulic line 10. The hydraulic line 10 can therefore be inserted into the receiving section 8 through the conical region 14, wherein the insertion depth is limited by the annular boundary surface 18.

A sealing means in the form of a cutting ring 22 is arranged on the hydraulic line 10 and has a first end region 24 shaped in the form of a sleeve. This end region has an end edge 26 and a second end region 28 facing away therefrom. The outside diameter of the first end region 24 increases slightly over a relatively short distance in the direction of the second end region 28 and then remains constant. Consequently, the end edge 26 is a kind of cutting edge. The surface gradient over the conical first end region 24 corresponds to the surface gradient of the conically shaped region of the opening 12. As a result, the cutting ring 22 can give rise to a uniform force which causes surface pressure in the radial direction, i.e. a force acting in the direction of a center line 32, when it is moved in the direction of the opening 12.

The second end region 28 has a first axial contact surface 30. By way of example, this is likewise of conical configuration. The outside diameter of the first axial contact surface 30 increases over a relatively short distance in the direction of the end edge 26 and then remains constant over a certain region.

A fastening element 34 has an engagement region 36, which surrounds the receiving section 8 in the illustration shown. Arranged opposite is a clamping region 38, which, on an inner side facing the engagement region 36, has a second axial contact surface 40 designed to correspond to the first axial contact surface 30. Both axial contact surfaces 30 and 40 are in surface contact with one another, and the fastening element 34 completely surrounds the cutting ring 22.

On an outer circumferential surface 42, the receiving section 8 has first engagement means 44, which are arranged by means of second engagement means 46 on an inner side of the engagement region 36. These can be embodied as threads, for example. The fastening element 34 can be firmly connected to the receiving section 8 by engagement of the engagement means 44 and 46, with the result that the cutting ring 22 is pressed into the opening 12. As a consequence, there is a build-up of material on the hydraulic line 10, which brings about sealing resistant to high pressure.

The receiving section has a first annular stop surface 48, with which a correspondingly shaped second annular stop surface 50 of the fastening element 34 comes into surface contact. The first annular stop surface 48 is arranged in a transitional region 52 of the receiving section 8 which performs a continuous taper or expansion of the outside diameter of the line end 6. A force acting locally in the axial direction can thereby be introduced very effectively into the line end 6 without causing notch effects.

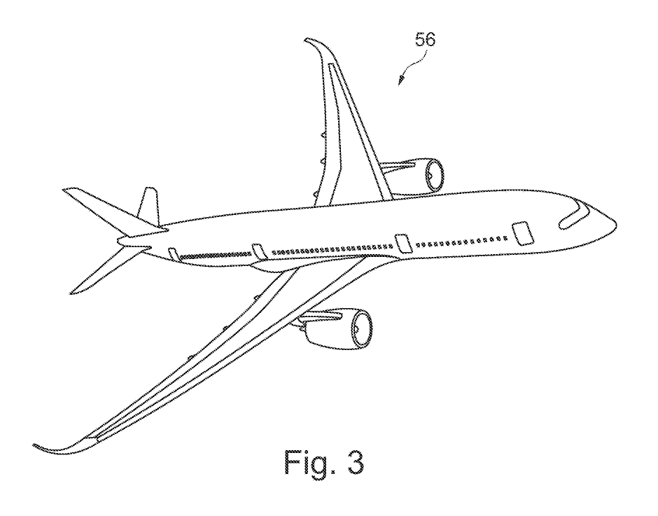

FIG. 2 depicts a hydraulic subassembly 54 with a number of hydraulic components 4, which are all equipped with a receiving section 8 explained above in order to implement an advantageous weight- and space-saving connection with hydraulic lines.

FIG. 3 shows an aircraft 56 which has at least one hydraulic component system 2 of this kind. The use of a hydraulic component system according to the disclosure to save weight and reduce production costs is suitable precisely in an aircraft.

For the sake of completeness, it should be noted that “having” does not exclude any other elements or steps and “a” or “an” does not exclude a multiplicity. It should furthermore be noted that features which have been described with reference to one of the above embodiment examples can also be used in combination with other features of other embodiment examples described above. Reference signs in the claims should not be regarded as restrictive.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A hydraulic component system, comprising:
at least one hydraulic line;
a hydraulic component, which is produced at least in part with the aid of a generative production method, comprising a line end with an integral annular receiving section having an outer circumferential surface that has first engagement means and an opening for the insertion of the hydraulic line, said opening tapering conically, at least in some region or regions;
an annular sealing means, which can be positioned on the hydraulic line; and
a hollow fastening element, which can be positioned on the hydraulic line and can be connected to the receiving section;
wherein the sealing means has a first end region and an opposite second end region having a first axial contact surface;
wherein the fastening element has an engagement region with an internal circumferential surface having second engagement means and has an opposite clamping region having a second axial contact surface facing the engagement region and is configured to surround the hydraulic line and the sealing means situated thereon and to bring about a surface contact between the first and the second axial contact surface; and
wherein the receiving section, the sealing means and the fastening element are configured to correspond to one another in such a way that the first end region of the sealing means is pressed into the conically tapering region of the opening of the receiving section and the hydraulic line by engagement of the first and second engagement means in one another and, as a result, sealing of the receiving section, the sealing means and the hydraulic line with respect to one another is accomplished.

2. The hydraulic component system according to claim 1, wherein the first end region of the sealing means is sleeve-shaped.

3. The hydraulic component system according to claim 1, wherein the sealing means is a cutting ring.

4. The hydraulic component system according to claim 1, wherein a first flow cross section formed within the receiving section corresponds to a second flow cross section formed within the hydraulic line.

5. The hydraulic component system according to claim 1, wherein:
the receiving section has a transitional region, which faces away from the opening and in which an outside diameter of the line end falls continuously along the line end from a maximum outside diameter to a constant line outside diameter in a direction away from the opening, and
an annular first stop surface, with which a correspondingly shaped annular second stop surface of the fastening element can be brought into surface contact, is formed on a side of the transitional region facing the opening.

6. The hydraulic component system according to claim 5, wherein the annular first stop surface is of conical design and an outside diameter increases from the outer circumferential surface towards the transitional region.

7. The hydraulic component system according to claim 1, wherein the opening has a conically tapering insertion region and a hollow-cylindrical region adjoining the latter, which has an annular boundary surface, which corresponds to an annular end face of the hydraulic line.

8. The hydraulic component system according to claim 1, wherein the diameter of the outer circumferential surface of the receiving section in such that the volume formed by the outer circumferential surface is at most 2.5 times that of the cavity enclosed by the outer circumferential surface.

9. The hydraulic component system according to claim 1, wherein the first engagement means extends over the entire outer circumferential surface, which extends as far as an end edge of the receiving section.

10. The hydraulic component system according to claim 9, wherein the second engagement means has an axial extent which corresponds at least to 0.9 times the axial extent of the first engagement means.

11. The hydraulic component system according to claim 1, wherein:
the sealing means is provided on the first end region with a tapering outside diameter;
the taper ends in an end edge; and
the taper is of corresponding design to the conically tapering opening of the receiving section.

12. The hydraulic component system according to claim 11, wherein the conically tapering opening and the first end region of the sealing means have mutually corresponding surface slopes which correspond to a surface angle in a range of from 20 to 30° relative to a longitudinal axis of the receiving section.

13. The hydraulic component system according to claim 1, wherein the first axial contact surface is a conically shaped annular surface.

14. A vehicle having at least one hydraulic component system according to claim 1.

15. The vehicle according to claim 14, wherein the vehicle is an aircraft.
